(19) United States
(12) Patent Application Publication
(10) Pub. No.: US 2012/0067783 A1
(43) Pub. Date: Mar. 22, 2012

(54) HYDROGEN SULFIDE SCAVENGER COMPOSITIONS, METHODS FOR MAKING AND PROCESSES FOR REMOVING HYDROGEN SULFIDE FROM LIQUID HYDROCARBON MEDIA

(76) Inventors: Gregory KAPLAN, Trevose, PA (US); Larry John Karas, Spring, TX (US)

(21) Appl. No.: 13/246,212

(22) Filed: Sep. 27, 2011

Related U.S. Application Data
(63) Continuation-in-part of application No. 12/886,695, filed on Sep. 21, 2010.

(51) Int. Cl. C10G 29/22; C09K 3/00

(52) U.S. Cl. 208/240; 252/189

(57) ABSTRACT

A method for reducing the amount of hydrogen sulfide present in liquid hydrocarbon media while minimizing the amount of corrosion in processing equipment contacting the liquid hydrocarbon media. The method includes adjusting a glyoxal solution to a pH of from about 2.5 to about 6.0 and dispersing the adjusted glyoxal solution in the liquid hydrocarbon media. A hydrogen sulfide scavenging composition and method for making are also provided.

### CROSS-REFERENCE TO RELATED APPLICATIONS

This application is a continuation-in-part application of and claims priority from, U.S. patent application Ser. No. 12/886,695 filed on September 21, 2010. The entire contents of U.S. Patent Application Serial No. 12/886,695 are incorporated herein by reference.

### FIELD OF THE INVENTION

This invention relates generally to processing liquid hydrocarbon media, and more particularly, to methods and scavenger compositions for removing hydrogen sulfide from liquid hydrocarbon media.

### BACKGROUND OF THE INVENTION

Hydrocarbon media may contain hydrogen sulfide, which is highly corrosive and poisonous in very small concentrations. The risk of exposure to hydrogen sulfide from handling hydrocarbon media is a health and safety concern during storage, transportation (shipping, truck or pipeline) and processing. Hydrogen sulfide is extremely reactive causing corrosion to equipment and, especially in refinery applications, poisons the catalysts downstream of the refinery process.

It is essential to remove hydrogen sulfide from hydrocarbon media before processing. One type of hydrogen sulfide scavenger that is available commercially is glyoxal. During production of glyoxal, acidic byproducts are often formed or added. These byproducts can lead to increased corrosion rates during hydrocarbon processing. When glyoxal is added to a liquid hydrocarbon media, the acidic byproducts, which are not soluble in the liquid hydrocarbon media, can settle out from the liquid hydrocarbon media into a separate aqueous phase. For example, the aqueous phase may run along the bottom of the processing or refinery equipment as small tributaries in pipelines or stagnate at the bottom of holding tanks. This acidic aqueous phase is highly corrosive and can cause troughing in the processing or refinery equipment.

What is needed is an improved method for removing hydrogen sulfide from a liquid hydrocarbon media without causing corrosion to processing equipment.

### BRIEF DESCRIPTION OF THE INVENTION

In one embodiment, a method for reducing the amount of hydrogen sulfide present in a liquid hydrocarbon media while minimizing the amount of corrosion in processing equipment contacting the liquid hydrocarbon media, said method includes adjusting a pH value of a glyoxal solution to a pH in a range of from about 2.5 to about 6.0 and dispersing the adjusted glyoxal solution in the liquid hydrocarbon media.

In another embodiment, a hydrogen sulfide scavenging composition having a pH in the range of from about 2.5 to about 6.0, the composition including a glyoxal solution and a neutralizing agent.

In another embodiment, a process for making a hydrogen sulfide scavenging composition includes adjusting a glyoxal solution with a neutralizing agent to a pH in a range of from about 2.5 to about 6.0.

The various embodiments provide an improved hydrogen scavenging process for liquid hydrocarbon media that reduces hydrogen sulfide while minimizing corrosion to processing equipment.

### DETAILED DESCRIPTION OF THE INVENTION

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

The modifier “about” used in connection with a quantity is inclusive of the stated value and has the meaning dictated by the context (e.g., includes the tolerance ranges associated with measurement of the particular quantity).

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

In one embodiment, a method for reducing the amount of hydrogen sulfide present in a liquid hydrocarbon media while minimizing the amount of corrosion in processing equipment contacting the liquid hydrocarbon media, said method includes adjusting a pH value of a glyoxal solution to a pH in a range of from about 2.5 to about 6.0 and dispersing the adjusted glyoxal solution in the liquid hydrocarbon media.

Any amount of hydrogen sulfide in the liquid hydrocarbon media may be reduced and the actual amount of residual hydrogen sulfide will vary depending on the starting amount. In one embodiment, the hydrogen sulfide levels are reduced to about 150 ppm by volume or less, as measured in the vapor phase, based on the volume of the liquid hydrocarbon media. In another embodiment, the hydrogen sulfide levels are reduced to 100 ppm by volume or less, as measured in the vapor phase, based on the volume of the liquid hydrocarbon media. In another embodiment, the hydrogen sulfide levels are reduced to 50 ppm by volume or less, as measured in the vapor phase, based on the volume of the liquid hydrocarbon media. In another embodiment, the hydrogen sulfide levels are reduced to 20 ppm by volume or less, as measured in the vapor phase, based on the volume of the liquid hydrocarbon media.

The liquid hydrocarbon media may be any type of liquid hydrocarbon media containing hydrogen sulfide. In one embodiment, the liquid hydrocarbon media includes, but is not limited to, crude oil, natural gas, condensate, heavy oil, processed residual oil, bituminous, coker oils, coker gas oils, fluid catalytic cracker feeds, gas oil, naphtha, FCC slurry, diesel fuel, fuel oil, jet fuel, gasoline, kerosene or vacuum residua. In another embodiment, the liquid hydrocarbon media is a light liquid hydrocarbon media or refined hydrocarbon media, such as natural gas or condensate. In one embodiment, the liquid hydrocarbon media may be at an elevated temperature. In another embodiment, the liquid hydrocarbon media may be at a temperature of from about ambient or room temperature to about 150° C. In another embodiment, the liquid hydrocarbon media may be at a temperature of from about 24° C. to about 150° C. In another embodiment, the liquid hydrocarbon media may be at a temperature of from about 40° C. to about 100° C.

The processing equipment in contact with the liquid hydrocarbon media may be any type of equipment that can be used for processing the liquid hydrocarbon media, such as pipelines, refineries, cargo vessels, storage vessels or holding tanks. Processing equipment subject to corrosion is generally processing equipment made of steel or alloys, such as carbon steel, but any type of processing equipment may be protected.

Glyoxal is a water-soluble aldehyde and may include oligomers of glyoxal. Glyoxal is commercially available as a 40 weight percent aqueous solution.

In one embodiment, the pH value of the glyoxal solution is adjusted to a pH in a range of from about 2.5 to about 6.0 with a neutralizing agent. The neutralizing agent may be any type of chemical compound that is capable of reacting with a strong acid and increasing the pH of the glyoxal solution to a pH in a range of from about 2.5 to about 6.0. In one embodiment, the neutralizing agent may be a base, including, but not limited to, metal oxides or hydroxides, alkali metal oxides or hydroxides, alkali metals of weak acids or amines. In another embodiment, the neutralizing agent may be a polymeric material capable of forming bonds with the acidic impurities in the glyoxal solution. In another embodiment, the metal oxide may be calcium oxide or magnesium oxide. In another embodiment, the metal hydroxide may be sodium hydroxide or potassium hydroxide. In another embodiment, the alkali metal of a weak acid may be calcium carbonate. In one embodiment, an amine may be triethanolamine. In another embodiment, the polymeric material may be an ion exchange resin.

The neutralizing agent is added in an effective amount to adjust the pH of the glyoxal solution to a pH in the range of from about 2.5 to about 6.0. In another embodiment, the glyoxal solution is adjusted to a pH in the range of from about 4.0 to about 6.0. In another embodiment, the pH range is from about 5.0 to about 6.0.

In one embodiment, the amount of neutralizing agent is from about 0.1 percent by weight to about 5 percent by weight, based on the weight of the glyoxal solution. In another embodiment, the neutralizing agent is present from about 0.1 percent by weight to about 2.5 percent by weight, based on the weight of the glyoxal solution. In another embodiment, the neutralizing agent is present from about 0.1 percent by weight to about 1 percent by weight, based on the weight of the glyoxal solution. In another embodiment, the neutralizing agent is present from about 0.1 percent by weight to about 0.5 percent by weight, based on the weight of the glyoxal solution.

The neutralizing agent may be blended with the glyoxal solution in any conventional manner. In one embodiment, a container with a neutralizing agent may be placed into a feeding line adding glyoxal solution into a liquid hydrocarbon media. In another embodiment, the neutralizing agents may be in cartridges or packed in columns and the glyoxal solution may be pumped through the packed columns or cartridges. In another embodiment, the neutralizing agent may be added directly to the glyoxal solution.

The adjusted glyoxal solution may be dispersed in the liquid hydrocarbon media in any conventional manner. In one embodiment, the adjusted glyoxal solution may be mixed or blended into the liquid hydrocarbon media. In another embodiment, the adjusted glyoxal solution may be dispersed within the liquid hydrocarbon media as the hydrocarbon media is transported through a pipe or tube. In one embodiment, the adjusted glyoxal solution may be delivered in metered amounts into the liquid hydrocarbon media. In another embodiment, a feeding system may be used to add the adjusted glyoxal solution to the liquid hydrocarbon media. The feeding system may include a pump and a storage container. In another embodiment, the adjusted glyoxal solution may be injected into the liquid hydrocarbon media by a conventional in-line injection system and may be injected at any point in-line suitable to allow the glyoxal solution to mix with the liquid hydrocarbon media. The adjusted glyoxal solution may be added to the liquid hydrocarbon media in a continuous manner or can be added in one or more batch modes and repeated additions may be made.

The adjusted glyoxal solution may be added to the liquid hydrocarbon media in any amount sufficient to reduce the levels of hydrogen sulfide in the liquid hydrocarbon media. In one embodiment, the adjusted glyoxal solution may be added in an amount of from about 1 ppm to about 20,000 ppm by volume, based on the volume of the liquid hydrocarbon media. In another embodiment, the adjusted glyoxal solution may be added in an amount of from about 1 ppm by volume to about 15,000 ppm by volume, based on the volume of the liquid hydrocarbon media. In another embodiment, the adjusted glyoxal solution may be added in an amount of from about 1 ppm by volume to about 10,000 ppm by volume, based on the volume of the liquid hydrocarbon media. In another embodiment, the adjusted glyoxal solution may be added in an amount of from about 10 ppm by volume to about 5000 ppm by volume, based on the volume of the liquid hydrocarbon media. In another embodiment, the adjusted glyoxal solution may be added in an amount of from about 50 ppm by volume to about 3000 ppm by volume, based on the volume of the liquid hydrocarbon media. In another embodiment, the adjusted glyoxal solution may be added in an amount of from about 100 ppm by volume to about 1200 ppm by volume, based on the volume of the liquid hydrocarbon media.

In the copending parent application (U.S. patent application Ser. No. 12/886,695), a glyoxal solution was neutralized and it was found that the neutralized glyoxal solution should be used within a period of 10 days to maintain the neutralized pH value. The inventors surprisingly discovered that adjusting a glyoxal solution to a pH value of from about 2.5 to about 6.0 created an adjusted glyoxal solution that was pH stable for extended periods of time. The inventors also surprisingly found that the kinetics of the glyoxal solution for scavenging hydrogen sulfide in liquid hydrocarbon media improved when the glyoxal solution was adjusted to a pH value in the range of from about 2.5 to about 6.0.

In another embodiment, a hydrogen sulfide scavenging composition includes a glyoxal solution and a neutralizing agent and has a pH in the range of from about 2.5 to about 6.0. A hydrogen sulfide scavenging composition reduces hydrogen sulfide levels in liquid hydrocarbon media. The pH value of the hydrogen sulfide scavenging composition is within the range of from about 2.5 to about 6.0, which reduces the corrosiveness of the glyoxal solution and protects the processing equipment and produces a pH stable composition with long storage times.

The glyoxal solution and neutralizing agent are described above. The neutralizing agent is added in an effective amount to adjust the glyoxal solution to a pH in the range of from about 2.5 to about 6.0. In another embodiment, the pH range is from about 4.0 to about 6.0. In another embodiment, the pH range is from about 5.0 to about 6.0.

In one embodiment, the amount of neutralizing agent is from about 0.1 percent by weight to about 5 percent by weight, based on the weight of the glyoxal solution. In another embodiment, the neutralizing agent is present from about 0.1 percent by weight to about 2.5 percent by weight, based on the weight of the glyoxal solution. In another embodiment, the neutralizing agent is present from about 0.1 percent by weight to about 1 percent by weight, based on the weight of the glyoxal solution. In another embodiment, the neutralizing agent is present from about 0.1 percent by weight to about 0.5 percent by weight, based on the weight of the glyoxal solution.

In another embodiment, a process for making a hydrogen sulfide scavenging composition includes adjusting a glyoxal solution with a neutralizing agent to a pH in a range of from about 2.5 to about 6.0. The neutralizing agent is added in an effective amount to adjust the glyoxal solution to a pH of from about 2.5 to about 6.0. In another embodiment, the pH range is from about 4.0 to about 6.0. In another embodiment, the pH range is from about 5.0 to about 6.0. In one embodiment, the amount of neutralizing agent is added to the glyoxal solution from about 0.1 percent by weight to about 5 percent by weight, based on the weight of the glyoxal solution. In another embodiment, the neutralizing agent is added to the glyoxal solution in an amount of from about 0.1 percent by weight to about 2.5 percent by weight, based on the weight of the glyoxal solution. In another embodiment, the neutralizing agent is added to the glyoxal solution in an amount of from about 0.1 percent by weight to about 1 percent by weight, based on the weight of the glyoxal solution. In another embodiment, the neutralizing agent is present from about 0.1 percent by weight to about 0.5 percent by weight, based on the weight of the glyoxal solution. The neutralizing agent and glyoxal solution are as described above.

The neutralizing agent may be added to the glyoxal solution in any conventional manner. In one embodiment, a container with a neutralizing agent may be placed into a feeding line adding glyoxal solution into a liquid hydrocarbon media. In one embodiment, the neutralizing agents may be in cartridges or packed in columns and the glyoxal solution is pumped through the packed columns or cartridges. In another embodiment, the neutralizing agent is added directly to the glyoxal solution.

In one embodiment, a catalyst may be added to the glyoxal solution to enhance the removal of the hydrogen sulfide. In one embodiment, the catalyst is a quaternary ammonium salt. The catalyst may be any suitable quaternary ammonium salt. In one embodiment, the catalyst has formula I:

R₁R₂R₃R₄N⁺X⁻

wherein R₁, R₂, R₃ and R₄ are each independently an alkyl group having from 1 to 30 carbon atoms, an aryl group having from 6 to 30 carbon atoms or an arylalkyl group having from 7 to 30 carbon atoms; and X is a halide, sulfate, nitrate or carboxylate. The alkyl groups and the aryl groups may be substituted or unsubstituted.

In one embodiment, R₁ is an alkyl group having from 1 to 24 carbon atoms. In one embodiment, R₂ is an alkyl having from 1 to 24 carbon atoms, an aryl group having from 6 to 24 carbon atoms or an arylalkyl group having from 7 to 24 carbon atoms.

In one embodiment, R₃ and R₄ are each, independently, an alkyl group having from 1 to 24 carbon atoms. In another embodiment, R₃ and R₄ are each, independently, an alkyl group having from 1 to 4 carbon atoms.

The alkyl group includes, but is not limited to, methyl, ethyl, propyl, isopropyl, butyl, isobutyl, pentyl, hexyl, decyl or dodecyl. The aryl group may be phenyl. The arylalkyl group include may be benzyl. The halide may be chloride, bromide or iodide. The sulfate may be a methyl sulfate. The nitrate may be a bisulfate nitrate. The carboxylate may be acetate.

In one embodiment, the quaternary ammonium salt is alkyl benzyl ammonium chloride or benzyl cocoalkyl (C₁₂-C₁₈) dimethylammonium chloride. In another embodiment, the quaternary ammonium salt includes, but is not limited to dicocoalkyl (C₁₂-C₁₈) dimethylammonium chloride, ditallowdimethylammonium chloride, di(hydrogenated tallow alkyl) dimethyl quaternary ammonium methyl chloride, methyl bis (2-hydroxyethyl cocoalkyl (C₁₂-C₁₈) quaternary ammonium choride, dimethyl(2-ethyl) tallow ammonium methyl sulfate, n-dodecylbenzyldimethylammonium chloride, n-octadecylbenzyldimethyl ammonium chloride, n-dodecyltrimethylammonium sulfate, soya alkyltrimethylammonium chloride or hydrogenated tallow alkyl (2-ethylhyexyl) dimethyl quaternary ammonium methyl sulfate.

In one embodiment, the catalyst is present from about 0.01 to about 15 percent by weight based on the weight of glyoxal. In another embodiment, the catalyst is present from about 1 to about 10 percent by weight based on the weight of glyoxal.

The catalyst may be added to the liquid hydrocarbon media simultaneously with the glyoxal solution or may be added separately from the glyoxal solution. In one embodiment, the catalyst is preblended with the glyoxal solution before being added to the liquid hydrocarbon media. The catalyst may be added to the glyoxal solution before the solution is neutralized, simultaneously with the addition of the neutralizing agents or after the glyoxal solution is neutralized.

In another embodiment, a corrosion inhibitor may be added to the liquid hydrocarbon media to provide protection to processing equipment in contact with the liquid hydrocarbon media. The corrosion inhibitor may be added to the liquid hydrocarbon media in any conventional manner. The corrosion inhibitor may be added to the liquid hydrocarbon media simultaneously with the glyoxal solution or may be added separately from the hydrogen sulfide scavenger composition. In one embodiment, the corrosion inhibitor may be injected into the liquid hydrocarbon media. In one embodiment, the corrosion inhibitor may be injected into the liquid hydrocarbon media by a conventional in-line injection system and may be injected at any point in-line suitable to allow the corrosion inhibitor to mix with the liquid hydrocarbon media. The corrosion inhibitor may be added to the liquid hydrocarbon media in a continuous manner or can be added in one or more batch modes and repeated additions may be made.

In another embodiment, the corrosion inhibitor may be preblended with the glyoxal solution before being added to the liquid hydrocarbon media. The corrosion inhibitor may be added to the glyoxal solution before the solution is neutralized, simultaneously with the addition of the neutralizing agents or after the glyoxal solution is neutralized.

The corrosion inhibitor disperses into the liquid hydrocarbon media and eventually contacts the processing equipment and deposits onto the processing equipment, forming a protective coating or film. The corrosion inhibitor may be added in any amount suitable for forming a protective coating or film on the processing equipment. In one embodiment, the corrosion inhibitor may be added to the liquid hydrocarbon media in an amount of from about 2 ppm by volume to about 200 ppm by volume, based on the volume of the liquid hydrocarbon media. In another embodiment, the corrosion inhibitor may be added to the liquid hydrocarbon media in an amount of from about 5 ppm by volume to about 100 ppm by volume, based on the volume of the liquid hydrocarbon media. In another embodiment, the corrosion inhibitor is added to the liquid hydrocarbon media in an amount of from about 10 ppm by volume to about 100 ppm by volume, based on the volume of the liquid hydrocarbon media. In another embodiment, the corrosion inhibitor is added to the liquid hydrocarbon media in an amount of from about 20 ppm by volume to about 100 ppm by volume, based on the volume of the liquid hydrocarbon media. The corrosion inhibitor may be added in a single batch or may be added in continuing dosages to the liquid hydrocarbon media.

The corrosion inhibitor may be any type of water-dispersible or oil-soluble compound. In one embodiment, the corrosion inhibitor may be a water-soluble corrosion inhibitor available commercially as Philmplus™ 5K 15 from GE Water.

As mentioned above, during production of glyoxal, acidic byproducts are often formed or added. When glyoxal is added to a liquid hydrocarbon media, the acidic by-products, which are not soluble in the liquid hydrocarbon media, can settle out from the liquid hydrocarbon media into a separate aqueous phase. Such phase may run along the bottom of the processing or refinery equipment as small tributaries in pipelines or stagnate at the bottom of holding tanks. This acidic aqueous phase is corrosive and can cause troughing in the processing or refinery equipment. In addition to the solutions presented above, another way to solve this problem, especially in the case of holding tanks, whether in oil tankers or land-based oil storage facilities, is to neutralize such acidic aqueous phase.

When the acidic aqueous phase is in the form of a small tributary, it can be difficult to locate the tributary for treatment. Moreover, the aqueous phase in some situations may be concentrated in one part of the equipment and not in another. However, in the case of holding tanks, whether land or sea-based, the size of the hydrocarbon media is very large, and the quantities of glyoxal needed are large. Moreover, since the hydrocarbon media in a storage equipment are relatively static (rather than moving in a pipeline), there is more danger for these insoluble materials to deposit at the bottom of the tank in large enough quantities such that a continuous or semi-continuous aqueous phase is formed, such as puddles or layers.

When glyoxal is insufficiently neutralized or not at all, the aqueous phase may be formed and may contain unreacted glyoxal up to about 40% by weight, such as about 0.1% to about 40% by weight glyoxal, and/or about 0.01 percent to about 1 percent of acidic components which originated from the glyoxal solution, such as one or more of the following components: formic acid, glycolic acid, acetic acid, oxalic acid and nitric acid. This aqueous phase is in contact with the liquid hydrocarbon media, and is continuous or semi-continuous.

The neutralizing agent can be added to the aqueous solution in an effective amount to result in an aqueous phase having a pH of 4 to 12. In another embodiment, the pH has a value of 7 to 11 and in another embodiment, the pH has a value of 8 to 10.

The amount of neutralizing agents used may be in the range of about 0.1 percent to about 5 percent by weight relative to the aqueous media, such as 0.1 percent to 2.5 percent, and 0.1 percent to 1 percent, and 0.1 percent to 0.5 percent. If excess volume is needed, the neutralizing agent can be added along with a diluent, such as water, to help spread the neutralizing agent to reach as much of the aqueous phase as possible. For example, the neutralizing agents can be diluted as much as 100-fold to increase their reach, such as a 2-fold to 100-fold dilution. In one embodiment, the total volume of the aqueous solution plus the neutralizing agent plus the diluent is less than 10% of the total volume of the tank holding the hydrocarbon media.

In order to determine the existence of an acidic aqueous phase, the tank holding the hydrocarbon media can have pH meters and/or corrosion coupons on or near bottom surfaces of the tank at different locations to determine the location of corrosion and acidity and, hence, the location of the acidic aqueous phase. Samples of the aqueous phase can also be removed for pH testing. The size of the aqueous phase can be determined by floaters that float on the aqueous phase and whose height can be determined, or the sides of the tanks can have glass portions for visual inspection of the presence of an aqueous phase. The neutralizing agents may be applied with one or more nozzles or outlets in close proximity to the aqueous media. Such outlets can be positioned at different locations in the tank depending on the tank's geometry or the location and amount of the aqueous media. For example, hoses or pipes extending from the top of the tank, or outlets on the bottom or sides of the tank may be utilized to supply the neutralizing agents.

One advantage of adding the neutralizing agent to the aqueous solution is that a higher pH can be utilized, if desired, without adding unnecessary neutralizing agents to the hydrocarbon media, which can degrade the glyoxal if used in excessive amounts. Also, the neutralizing liquid can be added to the holding tank before the glyoxal is added such that when the aqueous solution is formed on the bottom, the neutralizing liquid is already present to neutralize it.

In order that those skilled in the art will be better able to practice the present disclosure, the following examples are given by way of illustration and not by way of limitation.

### EXAMPLES

### Example 1

100 g of a 40% weight glyoxal solution having pH of 2.18 was blended with 0.57 g of TEA and let stand for 10 days at room temperature in a closed container. The pH was measured at 5.51. The glyoxal solution was left standing and tested again at 6 months. The pH was measured at 4.1. The glyoxal solution has good storage stability when adjusted to a pH between about 2.5 and 6.0.

### Example 2

100 g of a 40% weight glyoxal solution having pH of 2.18 was blended with 2.0 g of 10% weight solution of sodium hydroxide and let stand for 10 days at room temperature in a closed container. The pH was measured at 5.01. The glyoxal solution was left standing and tested again at 6 months. The pH was measured at 4.1. The glyoxal solution has good storage stability when adjusted to a pH between about 2.5 and 6.0.

### Example 3

Hydrogen sulfide removal was tested on a light condensate oil having 2000 ppm hydrogen sulfide in the head space. Adjusted glyoxal solutions (40% weight glyoxal) were compared with a commercial glyoxal solution (40% weight glyoxal) having a pH of 2.2. Testing was performed using a modified ASTM 5705-95 test that measures vapor phase H₂S at 75° F. via dragger tube.

Sample 1 was prepared by blending 100 g of the commercial glyoxal solution (40% weight glyoxal) having a pH of 2.2 with 0.4 g of TEA (triethanolamine). The pH was measured at 5.1. The adjusted glyoxal solution was blended with the light condensate and let stand for a period of time (see Table 1) at room temperature and tested for hydrogen sulfide.

Sample 2 was prepared by blending 100 g of the commercial glyoxal solution with 1 g of a 10% weight sodium hydroxide solution. The pH was measured at 5.2. The adjusted glyoxal solution was blended with the light condensate and let stand for a period of time (see Table 1) at room temperature and tested for hydrogen sulfide.

Table 1 shows the test results.

TABLE 1

| | | | Treatment | Time of | |
|---|---|---|---|---|---|
| | | | Amount | Reaction | H₂S Level |
| Sample | Treatment | pH | (ppm) | (min) | (ppm) |
| Blank | None | N/A | 0 | 0 | 2000 |
| CE-1 | Glyoxal¹ | 2.2 | 900 | 10 | 300 |
| | | | | 20 | 120 |
| | | | | 30 | 30 |
| | | | | 40 | 10 |
| | | | | 60 | 5 |
| CE-2 | Glyoxal¹ | 2.2 | 1000 | 10 | 300 |
| | | | | 20 | 160 |
| | | | | 30 | 30 |
| | | | | 40 | 10 |
| | | | | 60 | 5 |
| CE-3 | Glyoxal¹ | 2.2 | 1100 | 10 | 300 |
| | | | | 20 | 200 |
| | | | | 30 | 60 |
| | | | | 40 | 20 |
| | | | | 60 | 4 |
| 1 | Glyoxal² | 5.1 | 900 | 10 | 8 |
| | | | | 20 | 3 |
| | | | | 30 | 2 |
| | | | | 40 | 2 |
| | | | | 60 | 2 |
| 2 | Glyoxal³ | 5.2 | 900 | 10 | 10 |
| | | | | 20 | 5 |
| | | | | 30 | 2 |
| | | | | 40 | 2 |
| | | | | 60 | 2 |

¹Commercial glyoxal solution (40% by weight glyoxal)
²Glyoxal solution (40% by weight glyoxal) and TEA
³Glyoxal solution (40% by weight glyoxal) and sodium hydroxide

Samples 1 and 2 show a significant decrease in time for scavenging hydrogen sulfide compared with commercial glyoxal solutions. At 10 minutes, samples 1 and 2 were at or below the hydrogen sulfide level of the comparative examples after 40 minutes, which is a 75% reduction in time. By 20 minutes, samples 1 and 2 were at or below the hydrogen sulfide levels of the comparative examples after 60 minutes, which is a 67% reduction in time.

### Example 4

A glyoxal solution (40% by weight glyoxal) having a pH of 2.2 was adjusted to different pH values with a triethanol amine. Mild carbon steel coupons were placed in the different glyoxal solution compositions for 24 hours. Corrosion measurements were obtained by measuring weight loss of the steel coupons and extrapolated to mm/year corrosion rates as shown in Table 2.

TABLE 2

| | | Corrosion Rate | Corrosion |
|---|---|---|---|
| Samples | pH | (mm/yr) | Reduction |
| CE-4 | 2.2 (unadjusted) | 14.1 | 0% |
| 3 | 3.0 | 7.9 | 44% |
| 4 | 4.1 | 4.8 | 64% |
| 5 | 5.0 | 4.2 | 70% |
| 6 | 6.1 | 9.6 | 32% |
| 7 | 7.0 | 2.7 | 81% |

The above results show significant reduction in corrosion rate by pH adjustment. At a pH of higher than 6.0, corrosion reduction is obtained, but the glyoxal undergoes a Canizzaro reaction generating glycolic acid, which adds to the corrosive properties of the glyoxal solution. At a pH of at least 7.0, large amounts of neutralizing agent are needed and the storage times of the glyoxal solution are compromised.

While typical embodiments have been set forth for the purpose of illustration, the foregoing descriptions should not be deemed to be a limitation on the scope herein. Accordingly, various modifications, adaptations and alternatives may occur to one skilled in the art without departing from the spirit and scope herein.

Having described the invention that which is claimed is:

1. A method for reducing the amount of hydrogen sulfide present in a liquid hydrocarbon media while minimizing the amount of corrosion in processing equipment contacting the liquid hydrocarbon media, said method comprising adjusting a pH value of a glyoxal solution to a pH in a range of from about 2.5 to about 6.0 and dispersing the adjusted glyoxal solution in the liquid hydrocarbon media.

2. The method of claim 1 wherein the liquid hydrocarbon media is selected from the group consisting of crude oil, natural gas, condensate, heavy oil, processed residual oil, bituminous, coker oils, coker gas oil, fluid catalytic cracker feeds, gas oil, naphtha, FCC slurry, diesel fuel, fuel oil, jet fuel, gasoline, kerosene and vacuum residua.

3. The method of claim 2, wherein the liquid hydrocarbon media is a natural gas or condensate.

4. The method of claim 1 wherein the liquid hydrocarbon media is at a temperature of from about room temperature to about 150° C.

5. The method of claim 1 wherein the processing equipment is a pipeline or a holding tank.

6. The method of claim 5, wherein the processing equipment is made of carbon steel.

7. The method of claim 1, wherein the adjusted glyoxal solution is prepared by blending a neutralizing agent with the glyoxal solution, wherein said neutralizing agent is selected from the group consisting of metal oxides, metal hydroxides, alkali metals of weak acids, amines, ion-exchange resins and mixtures thereof.

8. The method of claim 7, wherein the amount of neutralizing agent is from about 0.1 percent by weight to about 5 percent by weight, based on the weight of the glyoxal solution.

9. The method of claim 7, wherein the neutralizing agent is placed into a feeding line adding a glyoxal solution into the liquid hydrocarbon media.

10. The method of claim 1, wherein the adjusted glyoxal solution is added to the liquid hydrocarbon media in an amount of from about 1 ppm to about 20,000 ppm by volume, based on the volume of the liquid hydrocarbon media.

11. The method of claim 7, wherein the neutralizing agent is in a cartridge or column and the glyoxal solution is pumped through the cartridge or column to produce an adjusted glyoxal solution.

12. The method of claim 1, wherein the adjusted glyoxal solution is delivered continuously to the hydrocarbon media in metered amounts.

13. The method of claim 1, wherein the glyoxal solution further comprises a catalyst.

14. The method of claim 13, wherein the catalyst is a quaternary ammonium salt.

15. The method of claim 14, wherein the catalyst has formula I:
R₁R₂R₃R₄N⁺X⁻
wherein R₁, R₂, R₃ and R₄ are each independently an alkyl group having from 1 to 30 carbon atoms, an aryl group having from 6 to 30 carbon atoms or an arylalkyl group having from 7 to 30 carbon atoms; and X is a halide, sulfate, nitrate or carboxylate.

16. The method of claim 15, wherein the quaternary ammonium salt is alkyl benzyl ammonium chloride or benzyl cocoalkyl (C₁₂-C₁₈) dimethylammonium chloride.

17. The method of claim 13, wherein the catalyst is present from about 0.01 to about 15 percent by weight based on the weight of glyoxal.

18. The method of claim 1, wherein a corrosion inhibitor is added to the liquid hydrocarbon media.

19. The method of claim 18, wherein the inhibitor is added to the liquid hydrocarbon media in an amount of from about 2 ppm by volume to about 200 ppm by volume, based on the volume of the liquid hydrocarbon media.

20. A hydrogen sulfide scavenging composition comprising a glyoxal solution and a neutralizing agent and having a pH in the range of from about 2,5 to about 6.0.

21. The scavenging composition of claim 20, wherein the neutralizing agent is selected from the group consisting of metal oxides, metal hydroxides, alkali metals of weak acids, amines, ion-exchange resins and mixtures thereof.

22. The scavenging composition of claim 20, wherein the amount of neutralizing agent is from about 0.1 percent by weight to about 5 percent by weight, based on the weight of the glyoxal solution.

23. The scavenging composition of claim 20, wherein the composition further comprises a catalyst.

24. The scavenging composition of claim 20, wherein the composition further comprises a corrosion inhibitor.

25. A process for making a hydrogen sulfide scavenging composition comprising adjusting a glyoxal solution with neutralizing agents to a pH in a range of from about 2.5 to about 6.0.

26. The process of claim 25, wherein the neutralizing agent is present from about 0.1 percent by weight to about 5 percent by weight, based on the weight of the glyoxal solution.

27. The process of claim 25, wherein the neutralizing agent is selected from the group consisting of metal oxides, metal hydroxides, alkali metals of weak acids, amines, ion-exchange resins and mixtures thereof.

28. The process of claim 25, wherein the neutralizing agent is in a cartridge or column and the glyoxal solution is pumped through the cartridge or column to produce an adjusted glyoxal solution.

29. The process of claim 25, wherein the process further comprises adding a catalyst to the composition.

30. The process of claim 25, wherein the process further comprises adding a corrosion inhibitor to the composition.

31. A method for reducing the amount of hydrogen sulfide present in a liquid hydrocarbon media contained in a land-or boat holding tank, while minimizing the amount of corrosion of the holding tank, the method comprising adding a glyoxal solution to the liquid hydrocarbon media, forming an aqueous solution containing acidic components from the glyoxal solution inside the holding tank, and adjusting the pH of the aqueous solution to a range of from 4 to 11, wherein the aqueous solution forms a phase in contact with the hydrocarbon media and the holding tank's inner surface, and wherein the phase is continuous or semi-continuous.

32. The method according to claim 31, wherein the aqueous solution contains a) 0.01% to 1% of one or more of formic acid, glycolic acid, acetic acid, oxalic acid and nitric acid, and/or 2) 0.1 to 40% of glyoxal, and wherein the pH is adjusted by the addition of one or more neutralizing agents in an amount of from about 0.1% to about 5% of the weight of the aqueous solution.
